(19) United States
(12) Patent Application Publication
(10) Pub. No.: US 2025/0119242 A1
(43) Pub. Date: Apr. 10, 2025

(54) Multi-Parameter Controlled Reliable Communication for Truly Wireless Devices

(71) Applicant: Google LLC, Mountain View, CA (US)

(72) Inventors: Xuemei Ouyang, Redwood City, CA (US); Po-wei Yeh, New Taipei City (TW); Dennis Yee, San Francisco, CA (US)

(73) Assignee: Google LLC, Mountain View, CA (US)

(21) Appl. No.: 18/729,445

(22) PCT Filed: Jan. 21, 2022
(86) PCT No.: PCT/US2022/013269

§ 371 Date: Jul. 16, 2024

(51) Int. Cl. H04L 1/1812; H04L 1/1803; H04L 5/00

(52) U.S. Cl. CPC H04L 1/1816; H04L 1/1803; H04L 5/0053

(57) ABSTRACT

The present disclosure provides systems and methods for transmitting data to a pair of truly wireless devices. A first device, which may be considered the primary device, may determine a first data packet was received. The first device may also determine the first data packet was not received by a second device of the pair of truly wireless devices. In response to determining the second device did not receive the first data packet, the first device may request the first data packet be retransmitted.

### BACKGROUND

Wireless headphones receive data transmitted from a host device, such as a smartphone. Unlike traditional wireless audio headsets, where the headphones are connected via a wired connection, truly wireless earbuds are connected wirelessly. Thus, when transmission conditions are poor, such that not all data is received by both headphones or data transmission is slow, an audio glitch may occur. An audio glitch may include stalled or skipped play back of the audio by the headphones. To minimize audio glitches, transmission techniques such as increasing the transmission power by the host device and beamforming the transmission signal towards the wireless headphones may be used. These transmission techniques may increase the signal quality between the wireless headphones and the host device, thereby increasing the amount of data that can be transmitted. However, these transmission techniques are typically limited by the wireless communication technology implemented in the host device. In that regard, some wireless communication technology may be incapable of altering transmission power and/or beamforming. Further, given the small form factor of many host devices, the benefits of these transmission techniques may be constrained.

Jitter buffers within the wireless headphones may also be used to reduce audio glitches. A jitter buffer may temporarily store audio data received from the host device and output the stored audio data for playback by the wireless headphones. The audio data stored in the jitter buffer may provide a playback cushion of a certain length of time should transmission conditions deteriorate between the host device and the headphones. For instance, the jitter buffer may store audio data received from a host device before playback by the wireless headphones begins. During playback of the audio, the jitter buffer may continue to receive the audio data from the host device while outputting the audio data received from the host device on a first-in first-out (FIFO) basis. In the event the transmission conditions deteriorate between the host device and the wireless headphones such that audio data is no longer received, or received at a slower rate than being output by the jitter buffer, the jitter buffer may continue to output audio data until the jitter buffer is empty. When transmission conditions improve before the jitter buffer empties, the wireless headphones may continue to play back audio uninterrupted. However, if the transmission conditions do not improve, the jitter buffer may empty and an audio glitch may occur.

### BRIEF SUMMARY

The present disclosure provides methods, systems, and computer-readable mediums for data transmission to truly wireless devices, such as a pair of earbuds. One aspect of the disclosure is directed to a method. The method may include determining, by a first device of the pair of truly wireless devices, a first data packet was received; determining, by the first device, the first data packet was not received by a second device of the pair of truly wireless devices; and in response to determining the second device did not receive the first data packet, requesting, by the first device, the first data packet be retransmitted.

In some instances, after determining the first data packet was not received by the second device, determining a time period since the first data packet was transmitted is less than a threshold amount of time.

In some instances, requesting the first data packet be retransmitted is further in response to determining the time period since the first data packet was transmitted is less than the threshold amount of time.

In some instances, the method further includes, after determining the first data packet was not received by the second device, determining a time period since the first data packet was transmitted is equal to or greater than a threshold amount of time.

In some instances, the method further includes, forwarding, by the first device, the first data packet to the second device after determining the time period since the first data packet was transmitted is equal to or greater than the threshold amount of time. In some examples, the method further includes requesting, by the first device, another data packet be transmitted.

In some instances, the method further includes, receiving, by the first device, a receipt acknowledgement sent by the second device after the second device received the first data packet. In some examples, the receipt acknowledgement is sent by the second device within a predetermined period of time.

In some instances, the first device a first earbud and the second device is a second earbud.

In some instances, the host device is a smartphone.

Another aspect of the disclosure is directed to a system. The system may include a first accessory, including one or more processors and a wireless communication interface, wherein the one or more processors are configured to determine a first data packet was received by the wireless communication interface; determine the first data packet was not received by a second device of the pair of truly wireless devices; and in response to determining the second device did not receive the first data packet, request the first data packet be retransmitted.

In some instances, the one or more processors are further configured to after determining the first data packet was not received by the second device, determine a time period since the first data packet was transmitted is less than a threshold amount of time. In some examples, requesting the first data packet be retransmitted is further in response to determining the time period since the first data packet was transmitted is less than the threshold amount of time.

In some instances, the one or more processors are further configured to after determining the first data packet was not received by the second device, determine a time period since the first data packet was transmitted is equal to or greater than a threshold amount of time.

In some instances, the one or more processors are further configured to forward, through the wireless communication interface, the first data packet to the second device after determining the time period since the first data packet was transmitted is equal to or greater than the threshold amount of time. In some examples, the one or more processors are further configured to request another data packet be transmitted.

In some instances, the one or more processors are further configured to receive, via the wireless communication interface, a receipt acknowledgement sent by the second device after the second device received the first data packet. In some examples, the receipt acknowledgement is sent by the second device within a predetermined period of time.

In some instances, the system further includes the second device, wherein the first device is a first earbud and the second device is a second earbud.

In some examples, the system further includes a host device, wherein the host device is configured to transmit the first data packet.

### BRIEF DESCRIPTION OF THE DRAWINGS

FIG. 1 is an illustration of a simultaneous communication issue encountered with known techniques of data transmission to truly wireless devices.

FIG. 2 is a pictorial diagram of an example system according to aspects of the disclosure.

FIG. 3 is a functional block diagram of an example system according to aspects of the disclosure.

FIG. 4 is another functional block diagram of an example system according to aspects of the disclosure.

FIG. 5 is a flow diagram illustrating a data transmission technique for transmitting data to truly wireless devices according to aspects of the disclosure.

### DETAILED DESCRIPTION

### Overview

The technology described herein is directed to a data transmission architecture for transmitting data from a host device to a pair of truly wireless devices, such as truly wireless earbuds. For instance, a host device, such as a smartphone may transmit a data packet (or collection of data packets) to the pair of truly wireless devices (“wireless devices”). One of the wireless devices may be a primary wireless device, such as a first earbud, and the other wireless device may be a secondary wireless device, such as a second earbud. Upon receipt of the data packet from the host device, the secondary wireless device may send an acknowledgement to the primary wireless device indicating that the secondary wireless device received the data packet from the host device. The primary wireless device may also determine whether it has received the data packet. In the event the primary wireless device received the data packet and an acknowledgment from the secondary wireless device that it also received the data packet, the primary wireless device may send a request to the host device to transmit another data packet.

However, if only the primary or secondary wireless device received the data packet, the primary wireless device may request the host device retransmit the data packet. In instances where the primary wireless device received the data packet but the secondary wireless device did not receive the data packet, the primary wireless device may continue to request the host device resend the data packet for a predefined period of time. After the predefined period of time, the primary wireless device may request the host device transmit the next packet and forward a copy of the data packet to the secondary wireless device.

By the primary wireless device requesting the next packet at the conclusion of the predefined time period, the jitter buffer in at least the primary buffer will likely not become empty due to only the secondary wireless device not receiving the data packet from the host device. Moreover, by providing a predefined period of time for the secondary wireless device to receive the data packet from the host device, the chances of the secondary wireless device receiving the data packet directly from the host device is increased. As such, the primary wireless device may forward the data packet to the secondary wireless device in situations where there is little to no chance that the secondary wireless device will receive the packet from the host device. Accordingly, the period of time such that the primary wireless device will be incapable of receiving data packets from the host device due to forwarding the data packet to the secondary wireless device will be minimized.

With typical data communication between a host device and wireless devices, the host device communicates with a single one of the wireless devices. In this regard, the host is typically unaware that there are a pair of truly wireless devices. Rather, the host device is aware of only one of the wireless devices, which is known as the primary wireless device. The secondary wireless device either receives data directly from the primary wireless device or attempts to capture the data being sent from the host device to the primary wireless device.

Current data transmission architectures that control communication between a host device and wireless devices typically include relay, sniffing, selective relay, and bi-directional selective relay architectures. With a relay architecture, a host device may send a data packet, such as an audio packet, to the primary wireless device (“PE”). The PE may then forward (i.e., “relay”), the data packet to the secondary wireless device (“SE”).

With a sniffing architecture, the host device may send a data packet to the PE. The SE may capture (i.e., “sniff”) transmissions from the host device intended for the PE. After the SE successfully sniffs a data packet, the SE may send an indication to the PE that it has received the packet. After the PE receives the data packet and the indication from SE that it received the data packet, the PE may request the next packet from the host device. Otherwise, when the PE did not receive the data packet or the SE did not provide an indication that it received the data packet, the PE may request the host device retransmit the data packet.

With a selective relay architecture the host device may send a data packet to the PE. The SE may capture transmissions from the host device intended for the PE. After the SE successfully sniffs a data packet, the SE may send an indication to the PE that it has received the packet. After the PE receives the data packet and the indication from SE that it too received the data packet, the PE may request the next packet from the host device. However, and unlike the sniffing architecture, in the event the PE does not receive an indication that the SE received the data packet, the PE may transmit the data packet to the SE directly. In this regard, retransmission of the data packet by the host device is only needed when the PE does not receive the data packet.

In the bi-directional selective relay architecture, the host device may send a data packet to the PE. The SE may capture transmissions from the host device intended for the PE. After the SE successfully sniffs a data packet, the SE may send an indication to the PE that it has received packet. Similarly, after the PE successfully receives the data packet, the PE may send an indication to the SE that it has received packet. In the event the PE receives the data packet and the indication from SE that it too received the data packet, the PE may request the next packet from the host device. In the event the PE receives the data packet but does not receive an indication that the SE received the data packet, the PE may transmit the data packet to the SE directly. Moreover, and unlike the selective relay architecture, after the SE receives the packet but the SE does not receive an indication that the PE received the data packet, the SE may transmit the data packet to the PE.

Each of the four aforementioned data transmission architectures may have advantages and disadvantages relative to each other. For instance, with the sniffing architecture, the SE can send a message indicating that SE received the data packet to the PE right after the SE receives the packet from the host device, such as a smartphone. As such, the PE can decide whether to request the host device to retransmit the packet right away within a Bluetooth protocol defined time. In this way, the smartphone can retransmit the packet to provide a chance for both wireless devices to receive the packet.

The Bluetooth protocol defined time may be a predefined period of time when the PE can provide a notification to the host device to resend a data packet to avoid the jitter buffer of the PE (and SE) from emptying. In this regard, when the PE receives the data packet (N) sent from the host device, but the SE did not (or has not provided an acknowledgement of receipt to the PE) the PE should ask host device to transmit a new packet so that the jitter buffer of the PE will not empty, thereby avoiding an audio glitch. At the same time, since the PE knows the SE did not receive the data packet N, the PE may request the host send a new data packet (N+1), and then the PE may relay the data packet N to SE.

A simultaneous communication may arise within the Bluetooth protocol defined time with the selective relay architecture. This is because the host device may send a new data packet (e.g., N+1) while the PE is relaying the old data packet (e.g., N) to the SE. As priority is given to PE-SE communication, the Host-PE communication may not be received. Thus, the host device may provide the new data packet (N+1) to the PE, but the PE may miss the transmission leading to inefficiencies and wasted resources.

The Bluetooth protocol defined time may be based on the jitter buffer length of the PE and/or SE. In this regard, the Bluetooth protocol defined time may be ¾ of the full jitter buffer length, or more or less. Such a jitter buffer length may be 40-400 ms, or more or less, dependent on the size of the jitter buffer length.

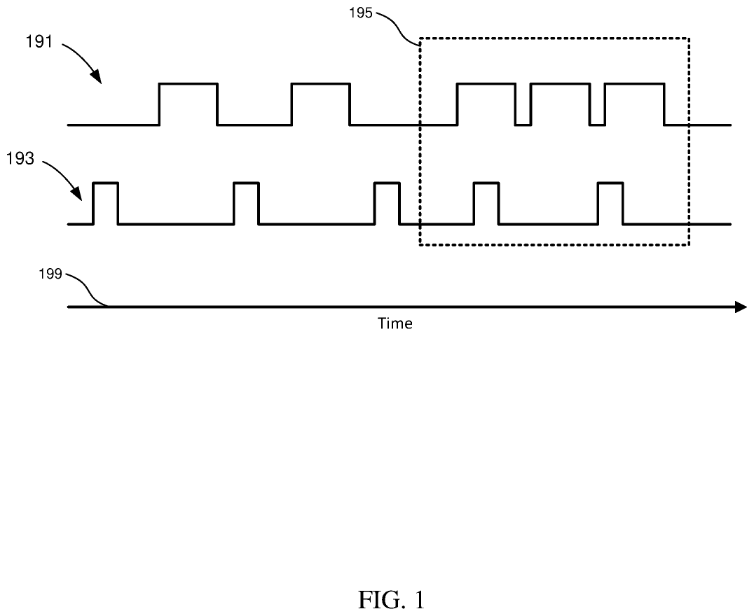

This simultaneous communication issue, where the host device sends a data packet but the PE is not listening for the data packet, may occur with the selective relay architecture when the SE does not receive a data packet is illustrated in FIG. 1. In this regard, data line 191 illustrates the communication between the host device (e.g., phone) and PE over a period of time, illustrated by line 199. Data line 193 illustrates the communication between the PE and the SE over the period of time 199. The portions of data lines 191 and 193 within box 195 illustrate PE sending a data packet to the SE, when the host device is sending a data packet to the PE. Since PE to SE data communication gets higher priority by the PE, during the overlapped period, the PE will transmit to the SE but will not receive new data packets from the host device. Thus, and as further illustrated in FIG. 1, the host device continues to retransmit the data packet to the PE. If the connection between the host device and the PE is not strong, the time the PE spends forwarding data packets to the SE will cause the PE to lose chances to receive data packets from phone. This may cause a dead loop which may drag down the performance of the PE, the SE, and in some instances the host device.

By implementing the data transmission architecture described herein this simultaneous communication issue may be avoided in most scenarios. In this regard, the data transmission architecture described herein allows for a SE to quickly confirm receipt of a data packet within the Bluetooth protocol defined time. The PE can then request the next data packet from the host device when it too has received the data packet. In the event one or other device did not receive the data packet, the PE can request the host device resend the data packet. As such, the PE device is not yet responsible for forwarding the data packet to the SE, and therefore will not suffer from the issues of simultaneous communication. It is only after the SE does not receive the data packet for a predetermined time that the PE may eventually forward the packet to the SE. Thus, only in circumstances where the SE is unlikely to receive the data packet from the host device is the PE relied on to forward the data packet, significantly reducing the chances of the simultaneous communication issue occurring.

### Example Systems

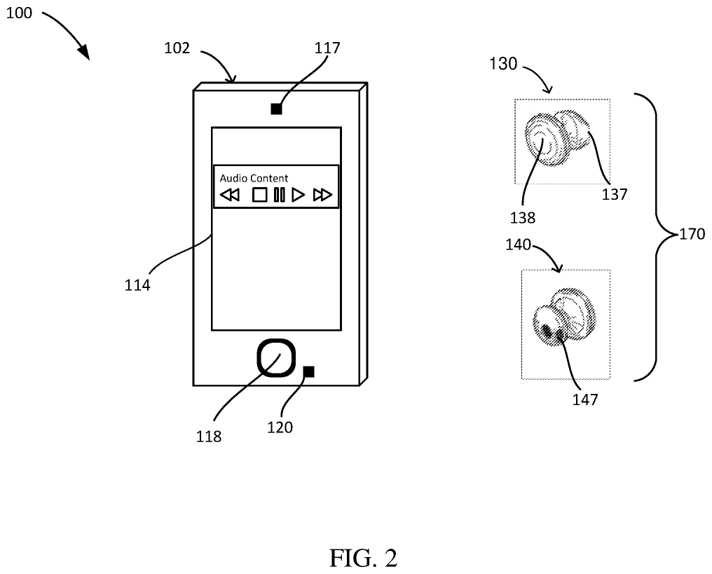

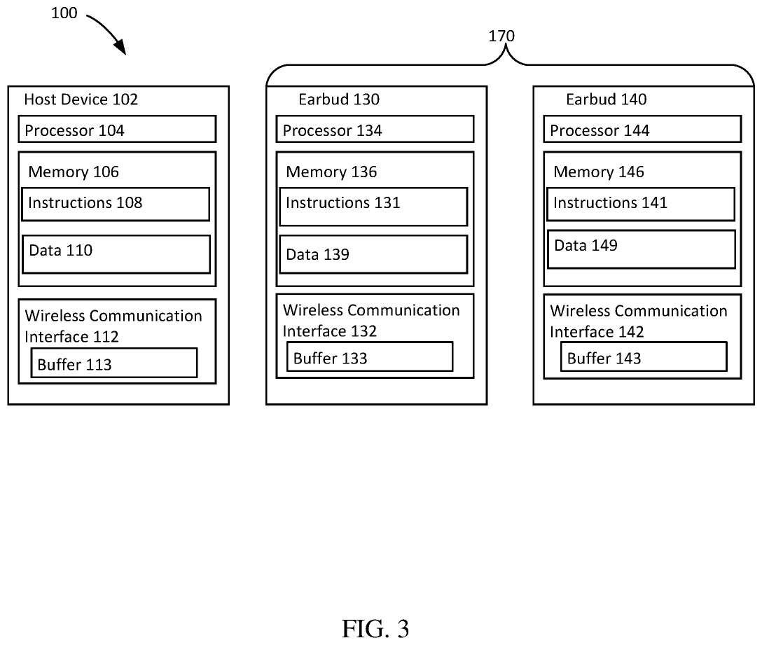

FIGS. 2 and 3 illustrate an example system 100 in which the features described herein may be implemented. It should not be considered limiting the scope of the disclosure or usefulness of the features described herein. In this example, system 100 includes a host device 102 and an accessory 170. The host device 102 is shown as a smartphone, and accessory 170 is shown as a pair of truly wireless earbuds 130, 140. The host device 102 may alternatively be any device capable of wirelessly communicating with an accessory, such as a mobile phone, personal computer, audio/video streaming device, netbook, wearable computing devices (e.g., smartwatch, smart glasses), gaming console, home assistant, etc. Accessory 170 may alternatively be any two devices capable of wirelessly receiving and playing back or outputting audio simultaneously, such as a wireless headset, wireless earbuds (e.g., earbuds connected together but configured to receive audio wirelessly), wearable computing devices, wireless speakers, home assistants, gaming consoles, etc.

Host device 102 and/or earbuds 130, 140 may be a personal computing device intended for use having some or all of the components normally used in connection with a personal computing device, as described herein, including a one or more processors (e.g., a central processing unit (CPU)), memory (e.g., RAM and internal hard drives) storing data and instructions, a display 114 (e.g., a monitor having a screen, a touch-screen, a projector, a television, or other devices such as a smartwatch display that is operable to display information), an output (e.g. speakers 117, 137, 147), and user input devices (e.g., touchpad 118, 138, keyboard, touchscreen or microphone 120).

As illustrated in FIG. 3, host device 102 may contain one or more processors 104, memory 106 storing instructions 108 and data 110, a wireless communication interface 112, and buffer 113. The host device 102 may be able to communicate with accessory 170 via the wireless communication interface 112.

The one or more processors 104 may be any conventional processors, such as commercially available microprocessors. Alternatively, the one or more processors may be a dedicated device such as an application specific integrated circuit (ASIC) or other hardware-based processor.

Memory 106 may store information that is accessible by the processors, including instructions 108 and data 110. The memory 106 may be a type of memory operative to store information (e.g., data 110, instructions 108, etc.,) accessible by the processors 104, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 108 and data 110 are stored on different types of media.

Data 110 may be retrieved, stored, or modified by processors 104 in accordance with the instructions 108. For instance, although the present disclosure is not limited by a particular data structure, the data 110 may be stored in computer registers, in a relational database as a table having a plurality of different fields and records, XML documents, or flat files. The data 108 may also be formatted in a computer-readable format such as, but not limited to, binary values, ASCII or Unicode. Moreover, the data 110 may comprise information sufficient to identify the relevant information, such as numbers, descriptive text, proprietary codes, pointers, references to data stored in other memories (including other network locations) or information that is used by a function to calculate the relevant data.

The instructions 108 can be any set of instructions to be executed directly, such as machine code, or indirectly, such as scripts, by the processor 104. In that regard, the terms “instructions,” “applications,” “steps,” and “programs” can be used interchangeably herein. The instructions can be stored in object code format for direct processing by the processor, or in any other computing device language, including scripts or collections of independent source code modules that are interpreted on demand or compiled in advance. Functions, methods, and routines of the instructions are explained in more detail below.

The host device 102 may further include a wireless communication interface 112, such as an antenna, transceiver, and any other devices used for wireless communication. The antenna may be, for example, a short-range wireless network antenna. The host device 102 may be coupled with accessory 170, including earbuds 130 and 140 via a wireless connection. For instance, the wireless communication interface 112 may be a Bluetooth controller configured to transmit and receive Bluetooth signals. As further shown in FIG. 3, wireless communication interface 112 may include an internal buffer 113, such as a jitter buffer. The buffer may store data, such as audio data. The data in buffer 113 may be transmitted by the wireless communication interface 112 to one or more accessories, such as earbuds 130, 140.

Although FIG. 3 functionally illustrates the processor 104, memory 106, and other elements of host device 102 as being within the same block, it will be understood that the processor, memory, and other elements of the host device 102 may include multiple processors, memory, and/or other components, that may or may not be stored within the same physical housing. Similarly, the memory may be a hard drive or other storage media located in a housing different from host device 102. Accordingly, references to a processor or computing device will be understood to include references to a collection of processors or computing devices that may or may not operate in parallel.

Accessories may each include one or more processors, memory, and wireless communication interfaces that are substantially similar to those described herein with respect to host device 102. For instance, earbud 130 includes processor 134, memory 136, and wireless communication interface 132, including internal buffer 133. Earbud 140 includes processor 144, memory 146, and wireless communication interface 142, including internal buffer 143. Wireless communication interfaces 132, 142 may be Bluetooth controllers capable of communication with wireless communication interface 112 of the host device and/or each other (e.g., wireless communication interface 132 may communicate with wireless communication interface 142.)

Although buffers 133 and 143 are shown as being within wireless communication interfaces, the buffers may be elsewhere within the accessory. For instance, buffer 133 may be in memory 136 or some other memory of earbud 130. The buffers 133 and 143 may be jitter buffers. The internal buffer of the accessory, including internal buffers 133, 143 of the earbuds 130, 140, respectively, may store data, such as audio data received from the host device 102.

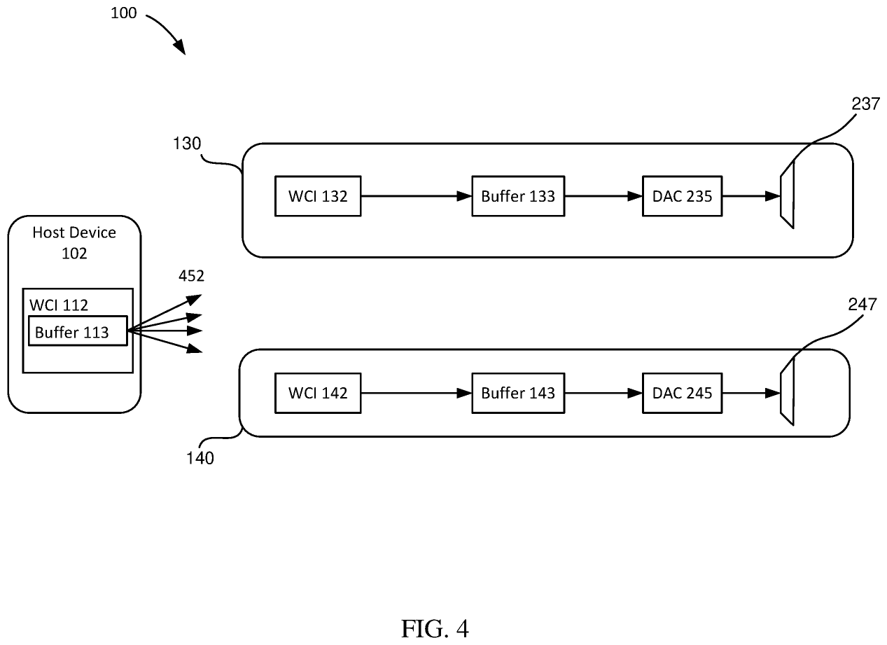

As previously described, one earbud, such as earbud 130, may be a primary wireless device (“PE”), and the other earbud 140 may be a secondary wireless device (“SE”). In this configuration, the host device may communicate with the PE. The SE may either sniff data intended for the PE or data may be forwarded from the PE to the SE. In one example, host device 102 may stream audio data to only one of the wireless communication interfaces of the earbuds. For example, and referring to FIG. 4, the wireless communication interface 112 may transmit a signal including audio data corresponding to a stereo audio file configured for playback by two speakers to the wireless communication interface 132 of primary earbud 130. The wireless communication interface 132, or some other component of earbud 130, such as processor 134, may parse the audio data into left channel data and right channel data. Depending on whether the earbud 130 is a left earbud or a right earbud, the accessory may transmit the other channel data, (i.e., left channel or right channel data), to the other accessory—earbud 140. For instance, if earbud 130 is a left earbud, earbud 130 may playback the left channel data through the speaker 237 and transmit the right audio channel to earbud 140, which is the right earbud, via wireless communication interface 132. Earbud 140 may receive and playback the right audio channel data through speaker 247.

Referring again to FIG. 4, host device 102 is shown as transmitting audio data, such as audio content (also referred to herein as an “audio file”), via signal 452 to primary earbud 130 of system 100. Secondary earbud 140 may be configured to sniff the signal 452. In this regard, the wireless communication interface 112 may intend to transmit signal 452 to wireless communication interface 132, but the signal 452 may be received by both wireless communication interfaces 132 and 142.

Before transmission, the wireless communication interface 112 may wrap the audio data into packets. Then, the individual packets may be transmitted over signal 452. Wireless communication interface 132 and 142 may store audio data received from signal 452 within internal buffers 133 and 143, respectively. The audio data received from signal 452 may be unwrapped from their respective packets before or after placement within the internal buffer 133 and 143. Although FIG. 4 illustrates internal buffers 133, 143 as outside of wireless communication interfaces 132, 142, respectively, the internal buffers 133, 143 may be within wireless communication interfaces 132, 142. The audio data within buffer 133 may be processed by digital-to-analog converter (DAC) 235 for playback by speaker 237. Likewise, the audio data within buffer 143 may be processed by DAC 245 for playback by speaker 247.

The amount of data that can be transmitted between wireless communication interfaces, such as wireless communication interface 112 and wireless communication interfaces 132, 142, may depend on the strength of the connection. As previously described, connection strength may be measured using a received signal strength indicator (RSSI), received signal power, and/or other such measures. Stronger connections may provide more reliable delivery of data, such as data packets. Conversely, weaker connections may lead to data loss, dropped packets, signal dropouts, and other issues, which may slow or otherwise prevent data transfer over the wireless connection.

### Example Methods

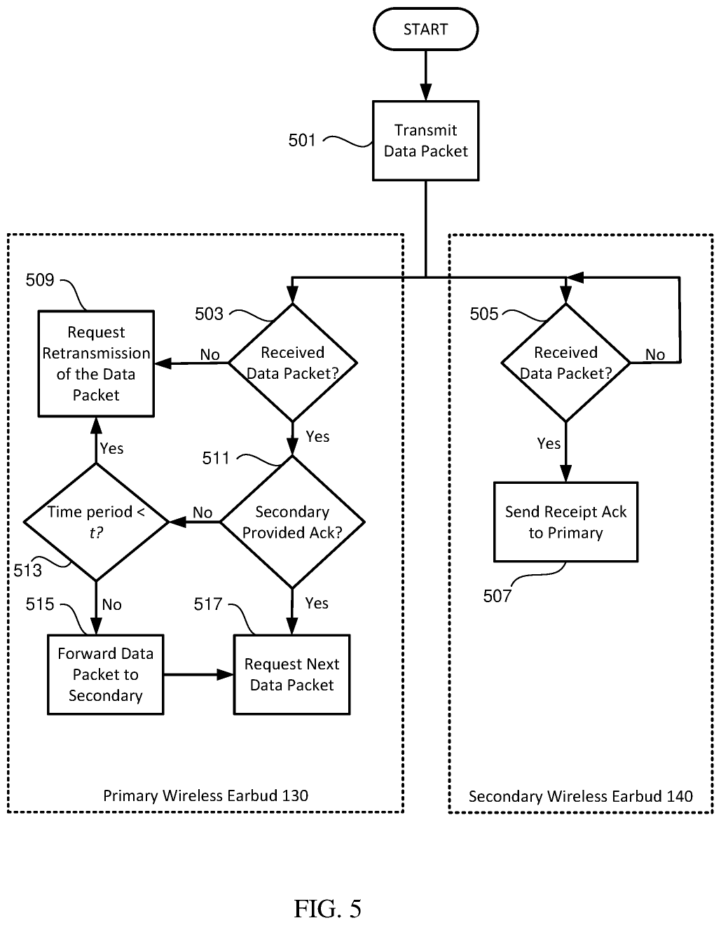

As described herein, the data transmission may be done in such a way that simultaneous communication issues that arise when a host device, such as host device 102, sends data to a primary wireless device, such as earbud 130, while earbud 130 is forwarding or otherwise transferring data to earbud 140 are minimized. The process is illustrated in flow diagram 500 of FIG. 5. As shown in block 501, the wireless communication interface 112 of host device 102 may transmit a data packet. The transmission of the data packet may be intended for the wireless communication interface 132 of primary earbud 130. However, the wireless communication interface 142 of the secondary earbud 140 may sniff the transmissions from the host device intended for the primary earbud 130.

At step 503, the primary earbud 130 may determine whether the data packet was received. For instance, processor 134 of primary earbud 130 may monitor wireless communication interface 132. If the processor 134 determines the data packet has not been received by the wireless communication interface 132, the primary earbud 130 may request the host device 102 retransmit the data packet, as shown by block 509. The request to retransmit the data packet may be sent by wireless communication interface 132 in response to an instruction from processor 134. In this regard, the host device typically transmits data packets in a regular time interval. The host device depends on the PE's response to decide whether to transmit a new packet (N+1) or retransmit the old packet (N). If after the host device transmits packet N and PE responds with ACK (acknowledgment of packet receiving), the host device will transmit the next packet N+1. During the whole process, the SE continues to “sniff” the traffic between host and PE.

As further described herein, in the event the PE receives the data packet N while the SE did not receive the data packet within a defined period of time (e.g., 40-400 ms), then within this period of time, PE will send a notification (NAC) to the host device indicating the data packet was not received so that the host device will retransmit the packet N. By doing such, the SE is provided more chances to receive the data packet N directly from host device. After the predefined period of time, if the PE determines that the SE cannot receive the packet SE's feedback to PE during the whole period, the PE may decide to move on with host device to avoid its jitter buffer emptying. Therefore, the PE may send a acknowledgement (ACK) to the host device so that host device will start to send the next data packet (N+1). At this time, the PE may then relay the packet N to SE. So SE will get packet N from PE and potentially get packet N+1 from the host device.

At the same time the primary earbud 503 is determining whether the data packet was received, the processor 144 of secondary earbud 140 may also determine whether wireless communication interface 142 has received the data packet transmitted by the host device 102, as illustrated by block 505. In the event the wireless communication interface 142 of secondary earbud 140 successfully sniffs the data packet, the secondary earbud may send an acknowledgement (“Ack”) of receipt of the data packet to the primary earbud 130, as illustrated by block 507. The acknowledgement may be sent automatically by the wireless communication interface 142 after receipt of the data packet or at the instruction of processor 144. The acknowledgement sent from the secondary earbud 140 to the primary earbud 130 may be made within the Bluetooth protocol defined time.

In the event the secondary earbud 140 does not successfully sniff the data packet, the secondary earbud 140 may continue to try and sniff the data packet, as shown by the “No” line off of block 505. In this case, the secondary earbud 140 will not provide an acknowledgement of receipt of the data packet until the data packet is received.

In the event the primary earbud 130 receives the data packet, the primary earbud 130 may determine whether a receipt acknowledgement (“Ack”) has been received from the secondary earbud 140, as shown in block 511. In this regard, processor 134 may track whether a receipt acknowledgement has been received from secondary earbud 140. If a receipt acknowledgement has been received, the processor 134 of primary earbud 130 may instruct wireless communication interface 132 to request the host device 102 provide the next data packet, as shown by block 517.

In the event the primary earbud 130 has received the data packet, but the secondary earbud 140 has not received the data packet, the processor may determine whether the amount of time since the host device 102 transmitted the data packet for the first time is less than time t, as illustrated by block 513. If the time since the data packet has been transmitted is less than time t, the primary earbud 130 may request the host device 102 resend the data packet. Time t may be 40-400 ms, or more or less, starting from the time when the data packet is first sent from the host device or from the time the data packet is first received by the PE. In the event the time period is equal to or greater than time t, the primary earbud 130 may transmit the data packet to the secondary earbud 140, as illustrated by block 515. Transmission of the data packet by the primary earbud to the secondary earbud may be done by the wireless communication interface 132 automatically or at the instruction of processor 134. After forwarding the data packet to the secondary earbud 140, the primary earbud 130 may request the host device provide the next data packet, as shown by block 517.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including,” and the like, should not be interpreted as limiting the subject matter of the claims to the specific examples; rather, the examples are intended to illustrate only one of many possible embodiments. Further, the same reference numbers in different drawings can identify the same or similar elements.

1. A method for transmitting data to a pair of truly wireless devices, the method comprising:
determining, by a first device of the pair of truly wireless devices, a first data packet was received;
determining, by the first device, the first data packet was not received by a second device of the pair of truly wireless devices; and
in response to determining the second device did not receive the first data packet, requesting, by the first device, the first data packet be retransmitted.

2. The method of claim 1, further comprising:
after determining the first data packet was not received by the second device, determining a time period since the first data packet was transmitted is less than a threshold amount of time.

3. The method of claim 2, wherein requesting the first data packet be retransmitted is further in response to determining the time period since the first data packet was transmitted is less than the threshold amount of time.

4. The method of claim 1, further comprising:
after determining the first data packet was not received by the second device, determining a time period since the first data packet was transmitted is equal to or greater than a threshold amount of time.

5. The method of claim 1, further comprising:
forwarding, by the first device, the first data packet to the second device after determining the time period since the first data packet was transmitted is equal to or greater than the threshold amount of time.

6. The method of claim 5, further comprising:
requesting, by the first device, another data packet be transmitted.

7. The method of claim 1, further comprising:
receiving, by the first device, a receipt acknowledgement sent by the second device after the second device received the first data packet.

8. The method of claim 7, wherein the receipt acknowledgement is sent by the second device within a predetermined period of time.

9. The method of claim 1, wherein the first device a first earbud and the second device is a second earbud.

10. The method of claim 1, wherein the host device is a smartphone.

11. A system, comprising:
a first accessory, including one or more processors and a wireless communication interface, wherein the one or more processors are configured to:
determine a first data packet was received by the wireless communication interface;
determine the first data packet was not received by a second device of the pair of truly wireless devices; and
in response to determining the second device did not receive the first data packet, request the first data packet be retransmitted.

12. The system of claim 11, wherein the one or more processors are further configured to:
after determining the first data packet was not received by the second device, determine a time period since the first data packet was transmitted is less than a threshold amount of time.

13. The system of claim 12, wherein requesting the first data packet be retransmitted is further in response to determining the time period since the first data packet was transmitted is less than the threshold amount of time.

14. The system of claim 11, wherein the one or more processors are further configured to:
after determining the first data packet was not received by the second device, determine a time period since the first data packet was transmitted is equal to or greater than a threshold amount of time.

15. The system of claim 11, wherein the one or more processors are further configured to:
forward, through the wireless communication interface, the first data packet to the second device after determining the time period since the first data packet was transmitted is equal to or greater than the threshold amount of time.

16. The system of claim 15, wherein the one or more processors are further configured to:
request another data packet be transmitted.

17. The system of claim 11, wherein the one or more processors are further configured to:
receive, via the wireless communication interface, a receipt acknowledgement sent by the second device after the second device received the first data packet.

18. The system of claim 17, wherein the receipt acknowledgement is sent by the second device within a predetermined period of time.

19. The system of claim 11, further comprising the second device, wherein the first device is a first earbud and the second device is a second earbud.

20. The system of claim 19, further comprising a host device, wherein the host device is configured to transmit the first data packet.
